(19) United States
(12) Patent Application Publication
(10) Pub. No.: US 2025/0276503 A1
(43) Pub. Date: Sep. 4, 2025

(54) METHOD PERFORMED IN A PRESS APPARATUS, PRESS APPARATUS AND RELEVANT COMPUTER PROGRAM

(71) Applicant: Quintus Technologies AB, Västerås (SE)

(72) Inventors: Per BURSTRÖM, Västerås (SE); Johan ENGLÉN, Västerås (SE); Martin SÖDERLUND, Västerås (SE)

(73) Assignee: Quintus Technologies AB, Västerås (SE)

(21) Appl. No.: 18/858,515

(22) PCT Filed: Apr. 27, 2022
(86) PCT No.: PCT/EP2022/061217

§ 371 Date: Oct. 21, 2024

(51) Int. Cl. B30B 1/00

(52) U.S. Cl. CPC B30B 1/007

(57) ABSTRACT

A method in a press apparatus is disclosed. The press apparatus comprises a pressure vessel and a guiding passage for guiding pressure medium out of the pressure vessel to reduce pressure in the pressure vessel. The guiding passage comprises a first flow restriction comprising a flow restriction body that is movable between at least a closed position and a maximally open position, wherein when the flow restriction body is moved out of the closed position an opening is created the size of which during controlled withdrawal of pressure medium from the pressure vessel is determined by: a first force acting on the flow restriction body to urge it either towards the maximally open position or towards the closed position, generated by an actuator, a second force acting on the flow restriction body to urge it towards the maximally open position, generated by a pressure of pressure medium in the guiding passage, and a third force acting on the flow restriction body to urge it towards the closed position if the first force acts on the flow restriction body to urge it towards the maximally open position, or towards the maximally open position if the first force acts on the flow restriction body to urge it towards the closed position, the third force being generated by a counterforce mechanism. The actuator is controlled in accordance with a predetermined relationship between the second force and the first force, for the particular third force, such that the pressure of pressure medium in the guiding passage is reduced over time in accordance with a pressure reduction sequence.

### TECHNICAL FIELD

The present invention generally relates to the field of high-pressure technology, in particular pressure treatment. More specifically, the present invention relates to a method for a press apparatus, and to a press apparatus. The press apparatus may be suitable for treatment of at least one article by means of pressure generated by means of a pressure medium, for example by means of isostatic pressing such as cold isostatic pressing (CIP), warm isostatic pressing (WIP) or hot isostatic pressing (HIP).

### BACKGROUND

An article to be subjected to pressure treatment by isostatic pressing such as cold isostatic pressing (CIP), warm isostatic pressing (WIP) or hot isostatic pressing (HIP) may be positioned in a pressure vessel arranged to hold pressure medium therein. A treatment cycle may comprise loading the article in the pressure vessel, closing and sealing the pressure vessel, treating the article in the pressure vessel, opening the pressure vessel, and unloading the article from the pressure vessel. Several articles may be treated simultaneously. The treatment cycle may be divided into several parts, or phases. After loading an article into the pressure vessel, the pressure vessel may then be sealed, followed by introduction of a pressure medium (e.g., comprising water) into the pressure vessel such that the pressure in the pressure vessel is increased to a certain pressure level, which may be referred to as a pressurization phase, whereby the article may be subjected to an increased pressure during a selected period of time. The treatment cycle may comprise a heating phase, wherein the pressure medium is heated, e.g., so as to achieve a desired or required temperature thereof. The heating phase may be carried out concurrently with the pressurization phase, before the pressurization phase, or after the pressurization phase. The subjecting of the article to an increased pressure in the pressure vessel during a selected period of time may be referred to as a pressing phase of the treatment cycle. After the pressing phase and prior to opening the pressure vessel to remove the article, the pressure in the pressure vessel is generally decreased to a sufficiently low level by withdrawing pressure medium from the pressure vessel. This may be referred to as a pressure reduction phase or pressure relief phase. The treatment cycle may further comprise a cooling phase. Depending on the type of isostatic press employed (e.g., whether the isostatic press is configured to carry out CIP, WIP or HIP), a cooling phase may however not be necessary. In some cases or applications, it may be desired to be able to decrease the pressure in the pressure vessel during the pressure reduction at different pressure decrease rates.

### SUMMARY

In some cases or applications, it may be desired or even required to be able to control the rate at which the pressure in the pressure vessel decreases during the pressure reduction phase with different precision at different stages during the pressure reduction phase. For example, the inventors have found out that during a pressure reduction phase and after the pressure in the pressure vessel has been decreased by a certain extent, it may be desired to be able to control the rate at which the pressure in the pressure vessel further decreases with a relatively high precision, whereas a less fine control of the rate at which the pressure in the pressure vessel decreases may be sufficient prior to that stage.

In view of the above, a concern of the present invention is to provide means for facilitating or allowing for controlling the rate at which the pressure in a pressure vessel of a press apparatus decreases with a relatively high precision.

A further concern of the present invention is to provide means for facilitating or allowing for controlling the rate at which the pressure in a pressure vessel of a press apparatus decreases with a relatively high precision during a selected portion of a pressure reduction phase.

To address at least one of these concerns and other concerns, a method for a press apparatus and a press apparatus in accordance with the independent claims are provided. Preferred embodiments are defined by the dependent claims.

According to a first aspect of the present invention, a method for a press apparatus is provided. The press apparatus comprises a pressure vessel arranged to hold pressure medium therein. The press apparatus comprises a guiding passage configured to connect the pressure vessel with a pressure medium sink and to withdraw pressure medium from the pressure vessel by guiding pressure medium from the pressure vessel towards the pressure medium sink, thereby reducing pressure in the pressure vessel. The guiding passage comprises at least a first flow restriction configured to control the extent to which pressure medium flow in the guiding passage is obstructed or impeded by controlling extent to which pressure medium flow is permitted through the first flow restriction. The first flow restriction comprises a flow restriction body that is movable between at least a closed position and a maximally open position. When the flow restriction body is moved out of the closed position an opening is created, wherein the size of the opening becomes larger the closer the flow restriction body is to the maximally open position. The extent to which pressure medium flow is permitted through the first flow restriction depends on the size of the opening if any. During controlled withdrawal of pressure medium from the pressure vessel the size of the opening is determined at least by (i) a first force acting on the flow restriction body to urge it either towards the maximally open position or towards the closed position, controllably and selectively generated by an actuator, (ii) a second force acting on the flow restriction body to urge it towards the maximally open position, generated by a pressure of pressure medium in the guiding passage, and (iii) a third force acting on the flow restriction body to urge it towards the closed position if the first force acts on the flow restriction body to urge it towards the maximally open position, or towards the maximally open position if the first force acts on the flow restriction body to urge it towards the closed position, which third force is generated by a counterforce mechanism. For example during controlled withdrawal of pressure medium from the pressure vessel, there may be a predetermined relationship between the second force and the first force, for the particular third force.

The size of the opening may be determined at least by the first force, the second force and the third force as mentioned in the foregoing during controlled withdrawal of pressure medium from the pressure vessel, which may be defined as withdrawal of pressure medium from the pressure vessel via the first flow restriction when the flow restriction body is away from the closed position but not in a fully open position or the maximally open position, in which case there is a predetermined relationship between the second force and the first force, for the particular third force. Such controlled withdrawal of pressure medium from the pressure vessel may in alternative be referred to as impeded withdrawal of pressure medium from the pressure vessel.

The predetermined relationship may be such that a combination of the first force and the second force is in balance with the third force while the flow restriction body is away from the closed position but not in a fully open position or the maximally open position. By a combination of the first force and the second force being in balance with the third force, it may be meant that there is no or only a very small net force acting on the flow restriction body such that the flow restriction body is in or very close to force equilibrium. Thus, for each value of a plurality of values or a set of values of the first force there may be a corresponding value of the second force resulting from that particular value of the first force generated by the actuator, for the particular third force, at which the flow restriction body is stationary or substantially stationary and is away from the closed position but not in a fully open position or the maximally open position.

The method according to the first aspect of the present invention comprises determining a plurality of values of the second force such that the corresponding values of the pressure of pressure medium in the guiding passage correspond to a pressure reduction sequence for reducing the pressure of pressure medium in the guiding passage over time. Based on the predetermined relationship, a plurality of values of the first force corresponding to the respective ones of the plurality of values of the second force are determined.

The method according to the first aspect of the present invention comprises, during at least a portion of time while pressure medium is being controllably withdrawn from the pressure vessel, controlling the actuator to generate the plurality of values of the first force such that the pressure of pressure medium in the guiding passage is reduced over time in accordance with the pressure reduction sequence.

The press apparatus may be suitable for treatment of at least one article by means of pressure generated by means of the pressure medium, for example by isostatic pressing such as cold isostatic pressing (CIP), warm isostatic pressing (WIP) or hot isostatic pressing (HIP). The at least one article may for example comprise one or more pieces of food and/or beverages or foodstuff, or a metal, ceramic, composite or plastic component. The pressure medium may in principle comprise or be constituted by any appropriate fluid. For example in relation to CIP and WIP, the pressure medium may for example comprise or be constituted by water or oil and/or any other suitable liquid. For example in relation to HIP, the pressure medium may for example comprise or be constituted by a gas, such as, for example, an inert gas such as argon gas.

As mentioned, said controlling of the actuator is carried out during at least a portion of time while pressure medium is being withdrawn from the pressure vessel. The at least a portion of time while pressure medium is being withdrawn from the pressure vessel may be defined as a period of time after the pressure in the pressure vessel—and thereby the pressure of pressure medium in the guiding passage—has been reduced so as to be below a certain pressure level. The pressure in the pressure vessel may be proportional to the pressure medium in the guiding passage. Thus, said controlling of the actuator may not be carried out at the beginning of the pressure reduction phase (i.e., at the start of the withdrawal of pressure medium from the pressure vessel) but only at a later stage during the pressure reduction phase. The point in time during the pressure reduction phase when said controlling of the actuator starts to be carried out or should start may depend on at least one of the pressure operating level(s) at which the first flow restriction is capable to operate and the length and/or the particular configuration or arrangement of the guiding passage between the pressure vessel and the first flow restriction. For example, the guiding passage between the pressure vessel and the first flow restriction may have varying dimension along the guiding passage, a meandering shape and/or multiple bends, which may increase the flow resistance for the pressure medium guided via the guiding passage from the pressure vessel towards the pressure medium sink.

The second force acting on the flow restriction body to urge it towards the maximally open position may be generated by a pressure of pressure medium in the guiding passage, upstream of and at the first flow restriction. The pressure in the pressure vessel may be proportional to the pressure medium in the guiding passage upstream of and at the first flow restriction.

As mentioned, during controlled withdrawal of pressure medium from the pressure vessel, there is a predetermined relationship between the second force and the first force, for the particular third force generated by the counterforce mechanism. The third force may be constant, or substantially constant. The third force may be set at manufacture of the first flow restriction, e.g., by choice of a certain type of counterforce mechanism. Thus, the third force may differ for different types of first flow restriction, but may otherwise be constant, or substantially constant. The counterforce mechanism may for example comprise a spring element that may be biased to generate the third force acting on the flow restriction body to urge it towards the closed position or towards the maximally open position. In such a case, the third force may be based on a spring constant of the spring element. The counterforce mechanism may for example comprise a spring or a gas spring (e.g., an air spring), which may be controllable.

The predetermined relationship between the second force and the first force, for the particular third force, may entail that for the particular third force, there are a plurality of values or a set of values of the first force, or a range of values of the first force, which result in a certain plurality of respective values of the second force or a certain set of respective values of the second force, or a certain range of respective values of the second force. Thus, according to the predetermined relationship, for each value of a plurality of values or a set of values of the first force there may be a corresponding value of the second force resulting from that particular value of the first force generated by the actuator.

As mentioned, it is determined, based on the predetermined relationship, a plurality of values of the second force such that the corresponding values of the pressure of pressure medium in the guiding passage correspond to a pressure reduction sequence for reducing the pressure of pressure medium in the guiding passage over time. The determination of the plurality of values of the second force may entail selecting values of the second force among the plurality of respective values of the second force or a certain set of respective values of the second force, or a certain range of respective values of the second force, as described in the foregoing, to form a succession of values of the second force for which the corresponding values of the pressure of pressure medium in the guiding passage are monotonically decreasing. Such monotonically decreasing values of the pressure of pressure medium in the guiding passage may form the pressure reduction sequence.

The predetermined relationship may for example have been established or determined by, for the particular third force generated by the counterforce mechanism, a set of measurements of values of the second force resulting from different values of the first force generated by the actuator, which measurements may have been carried out prior to the above-mentioned steps of the method according to the first aspect of the present invention, e.g., during controlled withdrawal of pressure medium from the pressure vessel. The measurements of values of the second force may for example be carried out by means of measurements of pressure of pressure medium in the guiding passage. Thus, the values of the second force must not necessarily be directly measured, but may be indirectly measured by means of, e.g., measurements of pressure of pressure medium in the guiding passage. Measurements of pressure of pressure medium in the guiding passage may for example be carried out by means of a pressure sensor as known in the art.

As mentioned, the first force acting on the flow restriction body to urge it towards the maximally open position or towards the closed position is controllably and selectively generated by the actuator. The flow restriction body may be referred to as the first flow restriction's modulating element. The first flow restriction may for example comprise at least one valve, such as, for example, at least one seat valve. The first flow restriction may for example comprise at least one needle valve. In case the first flow restriction comprises a valve, the flow restriction body may be referred to as the valve's modulating element. For example, in case the first flow restriction comprises a needle valve, the flow restriction body may comprise or be constituted by the needle-shaped plunger of the needle valve. The actuator may for example comprise a membrane actuator and a proportional pressure regulator, which proportional pressure regulator may be configured to act on the membrane actuator such that the membrane actuator generates the first force. The actuator may be configured such that the first force generated by the actuator can be varied stepwise, or continuously.

By means of the first force being controllably and selectively generated by the actuator and the predetermined relationship between the second force and the first force, for the particular third force, a very fine control of the reduction of the pressure of pressure medium in the guiding passage-and thereby of the pressure in the pressure vessel—may be facilitated or even allowed. The precision in the control of the reduction of the pressure of pressure medium in the guiding passage-and thereby of the pressure in the pressure vessel—may in principle only be limited by the predetermined relationship between the second force and the first force, for the particular third force. As indicated in the foregoing, the predetermined relationship may entail that there are a plurality of values or a set of values of the first force, or a range of values of the first force, which result in a certain plurality of respective values of the second force or a certain set of respective values of the second force, or a certain range of respective values of the second force. If the predetermined relationship has been (pre-)determined such that a relatively large number of corresponding values of the second force are known for different values of the first force (interpolation between different values might be used), the pressure reduction sequence may include a relatively large number of values, thereby facilitating or allowing for a fine control of the reduction of the pressure of pressure medium in the guiding passage—and thereby the pressure in the pressure vessel—by means of controlling the actuator to generate a plurality of values of the first force corresponding to the plurality of values of the second force such that the pressure of pressure medium in the guiding passage is reduced over time in accordance with the pressure reduction sequence. In particular, this may facilitate or allow for a high precision in controlling the rate of reduction of the pressure of pressure medium in the guiding passage—and thereby of the pressure in the pressure vessel. Further, by the predetermined relationship, such control may be achieved without or only with very limited need for corrective feedback, for example based on measurements of pressure in the pressure vessel, during the control. However, even though it is not required, such corrective feedback could be used during the control.

As mentioned, the size of the opening of the first flow restriction is determined at least by a first force acting on the flow restriction body to urge it either towards the maximally open position or towards the closed position, controllably and selectively generated by an actuator, a second force acting on the flow restriction body to urge it towards the maximally open position, generated by a pressure of pressure medium in the guiding passage, and a third force acting on the flow restriction body to urge it towards the closed position if the first force acts on the flow restriction body to urge it towards the maximally open position, or towards the maximally open position if the first force acts on the flow restriction body to urge it towards the closed position. Thus, the first flow restriction may either be a normally closed flow restriction—in case the actuator may be configured to controllably and selectively generate the first force acting on the flow restriction body to urge it towards the maximally open position and the third force may act on the flow restriction body to urge it towards the closed position—or a normally open flow restriction—in case the actuator may be configured to controllably and selectively generate the first force acting on the flow restriction body to urge it towards the closed position and the third force may act on the flow restriction body to urge it towards the maximally open position.

The actuator and/or the counterforce mechanism may be considered to be part(s) of the first flow restriction. Thus, the first flow restriction may comprise the actuator and/or the counterforce mechanism.

As mentioned, the predetermined relationship may be such that a combination of the first force and the second force is in balance with the third force while the flow restriction body is away from the closed position, but not in a fully open position or the maximally open position. By a combination of the first force and the second force being in balance with the third force, it may be meant that there is no or only a very small net force acting on the flow restriction body such that the flow restriction body is in or very close to force equilibrium. Thus, for each value of a plurality of values or a set of values of the first force there may be a corresponding value of the second force resulting from that particular value of the first force generated by the actuator, for the particular third force, at which the flow restriction body is stationary or substantially stationary and is away from the closed position but not in a fully open position or the maximally open position.

The guiding passage may comprise a second flow restriction. The second flow restriction may be configured to control the extent to which pressure medium flow in the guiding passage is obstructed or impeded by controlling the extent to which pressure medium flow is permitted through the second flow restriction. The second flow restriction may be arranged upstream the first flow restriction (e.g., the second flow restriction may be arranged closer to the pressure vessel, along the guiding passage, than the first flow restriction). Prior to the at least a portion of time, the second flow restriction may be controlled so as to not impede or obstruct pressure medium flow therethrough, thereby causing pressure medium to be withdrawn from the pressure vessel by the pressure medium being guided from the pressure vessel towards the pressure medium sink via the guiding passage.

The second flow restriction may be configured such that it can either impede or obstruct pressure medium flow or not impede or obstruct pressure medium flow. In other words, the second flow restriction may be configured such that it is either “off”, not impeding or obstructing pressure medium flow at all, or “on”, impeding or obstructing pressure medium flow. The second flow restriction may for example comprise at least one valve.

The withdrawal of pressure medium from the pressure vessel may be for reducing the pressure in the pressure vessel from a high pressure level towards a low pressure level. The second flow restriction may be configured such that it is capable of operating at one or more pressure levels which at least include the high pressure level. The first flow restriction may be configured such that it is capable of operating at one or more pressure levels which at least include an intermediate pressure level between the high pressure level and the low pressure level. The said controlling of the actuator may be carried out after the pressure in the pressure vessel has been reduced such that the pressure in the pressure vessel is equal to or less than the intermediate pressure level. The said controlling of the actuator may be carried out while the second flow restriction continues not to be obstructing or impeding pressure medium flow.

The one or more pressure operating levels at which the second flow restriction may be capable of operating at may for example be equal to or less than 16000 bar, equal to or less than 10000 bar, equal to or less than 8000 bar, or equal to or less than 6000 bar.

The one or more pressure operating levels at which the first flow restriction may be capable of operating at may for example be equal to or less than 800 bar, or equal to or less than 400 bar. The intermediate pressure level may hence for example be 800 bar, or 400 bar.

The press apparatus could possibly comprise one or more additional flow restrictions, each of which may be comprised in the guiding passage. Any of such one or more additional flow restrictions may be arranged downstream the first flow restriction (i.e., further away from the pressure vessel along the guiding passage than the first flow restriction), or upstream the first flow restriction (i.e., closer to the pressure vessel along the guiding passage than the first flow restriction) and possibly between the first flow restriction and the second flow restriction, or in parallel with the first flow restriction. Each or any of such one or more additional flow restrictions may be arranged similar to or the same as the first flow restriction, and may hence be configured to control the extent to which pressure medium flow in the guiding passage is obstructed or impeded by controlling extent to which pressure medium flow is permitted through the additional flow restriction, and the additional flow restriction may comprise a flow restriction body that is movable between at least a closed position and a maximally open position, such as for the first flow restriction as described herein. For each or any of such one or more additional flow restrictions there may be associated an actuator and/a counterforce mechanism, similarly or the same as for the first flow restriction as described herein. The associated actuator and/counterforce mechanism may be considered to be part(s) of the additional flow restriction, which hence may comprise the associated actuator and/or counterforce mechanism. For each or any of such one or more additional flow restrictions, the associated actuator may be controlled similarly or in the same way as the said controlling of the actuator associated with or comprised in the first flow restriction as described herein.

The first flow restriction and each additional flow restriction (if any) may be configured to have different pressure operating levels at which they are capable of operating at. For example, the first flow restriction may be capable of operating at one or more pressure levels between 0 bar and 800 bar, and an additional flow restriction, which may be arranged downstream the first flow restriction, may have be capable of operating at one or more pressure levels between 0 bar and 400 bar. Such configurations may further facilitate for a high precision in controlling the rate of reduction of the pressure of pressure medium in the guiding passage—and thereby of the pressure in the pressure vessel—particularly over a relatively large range of pressure of pressure medium in the pressure vessel.

According to a second aspect of the present invention, a press apparatus is provided. The press apparatus comprises a pressure vessel arranged to hold pressure medium therein. The press apparatus comprises a guiding passage configured to connect the pressure vessel with a pressure medium sink and to withdraw pressure medium from the pressure vessel by guiding pressure medium from the pressure vessel towards the pressure medium sink, thereby reducing pressure in the pressure vessel. The press apparatus comprises at least a first flow restriction comprised in the guiding passage and configured to control the extent to which pressure medium flow in the guiding passage is obstructed or impeded by controlling extent to which pressure medium flow is permitted through the first flow restriction. The first flow restriction comprises a flow restriction body that is movable between at least a closed position and a maximally open position, wherein when the flow restriction body is moved out of the closed position an opening is created, wherein the size of the opening becomes larger the closer the flow restriction body is to the maximally open position. The extent to which pressure medium flow is permitted through the first flow restriction depends on the size of the opening if any. During controlled withdrawal of pressure medium from the pressure vessel, the size of the opening is determined at least by (i) a first force acting on the flow restriction body to urge it either towards the maximally open position or towards the closed position, controllably and selectively generated by an actuator, (ii) a second force acting on the flow restriction body to urge it towards the maximally open position, generated by a pressure of pressure medium in the guiding passage, and (iii) a third force acting on the flow restriction body to urge it towards the closed position if the first force acts on the flow restriction body to urge it towards the maximally open position, or towards the maximally open position if the first force acts on the flow restriction body to urge it towards the closed position, the third force being generated by a counterforce mechanism. During the controlled withdrawal of pressure medium from the pressure vessel there may be a predetermined relationship between the second force and the first force, for the particular third force. The press apparatus comprises at least one control and/or processing unit. The at least one control and/or processing unit is configured to determine a plurality of values of the second force such that the corresponding values of the pressure of pressure medium in the guiding passage correspond to a pressure reduction sequence for reducing the pressure of pressure medium in the guiding passage over time, and determine, based on the predetermined relationship, a plurality of values of the first force corresponding to the respective ones of the plurality of values of the second force. The at least one control and/or processing unit is configured to, during at least a portion of time while pressure medium is being controllably withdrawn from the pressure vessel, control the actuator to generate the plurality of values of the first force such that the pressure of pressure medium in the guiding passage is reduced over time in accordance with the pressure reduction sequence.

The at least one control and/or processing unit could comprise a processing unit and a control unit. The processing unit may be configured to carry out the said determination of a plurality of values of the second force, and the control unit may be configured to carry out said controlling of the actuator.

The at least one control and/or processing unit may for example include or be constituted by one or more of any suitable central processing unit (CPU), microcontroller, programmable logic controller (PLC), digital signal processor (DSP), Application Specific Integrated Circuit (ASIC), Field Programmable Gate Array (FPGA), etc., or any combination thereof. The at least one control and/or processing unit may optionally be capable of executing software instructions stored in a computer program product, e.g., in the form of a memory. The memory may for example be any combination of read and write memory (RAM) and read only memory (ROM). The memory may comprise persistent storage, which for example can be a magnetic memory, an optical memory, a solid state memory or a remotely mounted memory, or any combination thereof.

According to a third aspect of the present invention, a computer program is provided. The computer program comprises instructions, which when executed by one or more processors comprised in at least one control and/or processing unit, cause the at least one control and/or processing unit to perform the method according to the first aspect of the present invention.

According to a fourth aspect of the present invention, a processor-readable medium is provided. The processor-readable medium has a computer program loaded thereon, wherein the computer program comprises instructions, which, when executed by one or more processors comprised in at least one control and/or processing unit, cause the at least one control and/or processing unit to perform the method according to the first aspect of the present invention.

Each or any of the one or more processors may for example comprise a CPU, a microcontroller, a PLC, a DSP, an ASIC, an FPGA, etc., or any combination thereof. The processor-readable medium may for example include a Digital Versatile Disc (DVD) or a floppy disk or any other suitable type of processor-readable means or processor-readable (digital) medium, such as, but not limited to, a memory such as, for example, non-volatile memory, a hard disk drive, a Compact Disc (CD), a Flash memory, magnetic tape, a Universal Serial Bus (USB) memory device, a Zip drive, etc.

Further objects and advantages of the present invention are described in the following by means of exemplifying embodiments. It is noted that the present invention relates to all possible combinations of features recited in the claims. Further features of, and advantages with, the present invention will become apparent when studying the appended claims and the description herein. Those skilled in the art realize that different features of the present invention can be combined to create embodiments other than those described herein.

### BRIEF DESCRIPTION OF THE DRAWINGS

Exemplifying embodiments of the present invention will be described below with reference to the accompanying drawings.

Each of FIGS. 1 and 2 is a schematic view of a press apparatus according to an embodiment of the present invention.

FIG. 3 is a schematic view of a first flow restriction in accordance with an embodiment of the present invention.

FIG. 4 is a schematic graph for illustrating principles of embodiments of the present invention.

FIGS. 5 and 6 are schematic flowcharts illustrating methods according to embodiments of the present invention.

Each of FIGS. 7 to 9 is a schematic view of a press apparatus according to an embodiment of the present invention.

FIG. 10 is a schematic view of a first flow restriction in accordance with an embodiment of the present invention.

The figures are schematic, not necessarily to scale, and generally only show parts which are necessary in order to elucidate embodiments of the present invention, wherein other parts may be omitted or merely suggested.

### DETAILED DESCRIPTION

The present invention will now be described hereinafter with reference to the accompanying drawings, in which exemplifying embodiments of the present invention are illustrated. The present invention may, however, be embodied in many different forms and should not be construed as limited to the embodiments of the present invention set forth herein; rather, these embodiments are provided by way of example so that this disclosure will convey the scope of the present invention to those skilled in the art.

FIG. 1 is a schematic view of a press apparatus 1 according to an embodiment of the present invention. It is to be noted that all depicted components of the press apparatus 1 are illustrated in FIG. 1 only very schematically.

The press apparatus 1 comprises a pressure vessel 2, which is arranged to hold pressure medium therein. The pressure vessel 2 may for example be cylindrical in shape. The press apparatus 1 may be suitable for treatment of at least one article (not shown in FIG. 1) by means of pressure generated by means of the pressure medium, for example by isostatic pressing such as cold isostatic pressing (CIP), warm isostatic pressing (WIP) or hot isostatic pressing (HIP). The at least one article may for example comprise one or more pieces of food and/or beverages or foodstuff, or a metal, ceramic, composite or plastic component. The pressure medium may in principle comprise or be constituted by any appropriate fluid. For example in relation to CIP and WIP, the pressure medium may for example comprise or be constituted by water or oil and/or any other suitable liquid. For example in relation to HIP, the pressure medium may for example comprise or be constituted by a gas, such as, for example, an inert gas such as argon gas.

A treatment cycle may comprise loading the article(s) in the pressure vessel 2, closing and sealing the pressure vessel 2, treating the article in the pressure vessel 2, opening the pressure vessel 2, and unloading the article from the pressure vessel 2. The pressure vessel 2 may have one or more closures (not shown in FIG. 1) that can be opened and closed for placing the article(s) within the pressure vessel 2 before treatment of the article(s) and for removing the article(s) from the pressure vessel 2 after the treatment is completed. For example in case the pressure vessel 2 is cylindrical in shape, an end closure may be arranged at one or each of the ends of the pressure vessel 2. The press apparatus 1 may comprise a load compartment (not shown in FIG. 1) in which the article(s) are arranged. The load compartment, which for example may comprise a load basket, may be removably arranged in the pressure vessel 2 so that it can be arranged in the pressure vessel 2 and subsequently removed from the pressure vessel 2.

The treatment cycle may be divided into several parts, or phases. After loading an article into the pressure vessel 2, the pressure vessel 2 may then be closed and sealed, followed by introduction of the pressure medium into the pressure vessel 2 such that the pressure in the pressure vessel 2 is increased to a desired pressure level, which may be referred to as a pressurization phase. Means for introducing pressure medium into the pressure vessel 2 are as such known in the art and are not shown in FIG. 1. The pressure in the pressure vessel 2 may be kept at or close to the desired pressure level during a selected period of time. Thereby, the article may be subjected to an increased pressure during a selected period of time. The introduction of the pressure medium into the pressure vessel 2 and the subjecting of the article to an increased pressure during a selected period of time may be referred to as a pressing phase. The treatment cycle may comprise a heating phase, wherein the pressure medium is heated, e.g., so as to achieve a desired or required temperature thereof. The heating phase may be carried out concurrently with the pressurization phase, before the pressurization phase, or after the pressurization phase.

After the pressing phase and prior to opening the pressure vessel to remove the article, the pressure in the pressure vessel 2 should be decreased to a sufficiently low level by withdrawing pressure medium from the pressure vessel 2. This may be referred to as a pressure reduction phase. To that end, the press apparatus 1 comprises a guiding passage 3, which is configured to connect the pressure vessel 2 with a pressure medium sink 4 and to withdraw pressure medium from the pressure vessel 2 by guiding pressure medium from the pressure vessel 2 towards the pressure medium sink 4, thereby reducing pressure in the pressure vessel 2. The guiding passage 3 may be defined for example by the interior of one or more pipes, tubes or conduits, which may be fluidly coupling the pressure vessel 2 with the pressure medium sink 4. Thus, the guiding passage 3 may for example be implemented or realized by one or more pipes, tubes or conduits which may be fluidly coupling the pressure vessel 2 with the pressure medium sink 4.

The treatment cycle may further comprise a cooling phase. Depending on the type of isostatic press employed (e.g., whether the isostatic press is configured to carry out CIP, WIP or HIP), a cooling phase may however not be necessary.

The pressure medium sink 4 may for example comprise a pressure medium reservoir, which may be configured to hold pressure medium and allow for reuse of pressure medium in the pressure vessel 2. The pressure medium sink 4 could in alternative—at least if the pressure medium does not comprise any hazardous substances, e.g., if the pressure medium comprises pure water or substantially pure water—comprise a drain, which may be coupled to sewers underneath a building in which the press apparatus 1 is installed. It is however to be understood that the pressure medium sink 4 could comprise in principle any body, element, component, etc. that is capable of at least momentarily storing pressure medium and/or disposing pressure medium.

The press apparatus 1 comprises a first flow restriction 5, which is comprised in the guiding passage 3 and is configured to control the extent to which pressure medium flow in the guiding passage 3 is obstructed or impeded, by controlling extent to which pressure medium flow is permitted through the first flow restriction 3. The first flow restriction 5 may for example comprise at least one valve, such as, for example, at least one seat valve. The first flow restriction 5 may for example comprise or be constituted by at least one needle valve.

The guiding passage 3 may be configured to provide a certain flow resistance for the pressure medium guided from the pressure vessel 2 towards the pressure medium sink 4 when the first flow restriction 5 is kept completely ‘open’, i.e., when the first flow restriction 5 is not obstructing or impeding pressure medium flow at all, while pressure medium is being withdrawn from the pressure vessel 2. In alternative or in addition to the guiding passage 3 being configured in such a way (e.g., by its construction or design), the guiding passage 3 may be provided with some component, element, unit, etc., which provides such flow resistance. A certain flow resistance may be desired or even required in order to obtain a certain pressure drop over a length of the guiding passage 3 to ensure that wear on the components in the press apparatus 1 subjected to the flow of pressure medium does not become too high due to cavitation that may occur in flows or pressure medium at a combination of relatively low pressure and relatively high pressure medium flow speeds, and to ensure that the one or more pressure levels at which the different components (e.g., the first flow restriction) are capable of operating at is/are not exceeded.

In accordance with the embodiment of the present invention illustrated in FIG. 1, the press apparatus 1 comprises a second flow restriction 6. Just as the first flow restriction 5, the second flow restriction 6 is also comprised in the guiding passage 3. And just as the first flow restriction 5, the second flow restriction 6 is also configured to control the extent to which pressure medium flow in the guiding passage 3 is obstructed or impeded by controlling the extent to which pressure medium flow is permitted through the second flow restriction 6. As illustrated in FIG. 1, the second flow restriction 6 is arranged upstream the first flow restriction 5 (i.e., closer to the pressure vessel 2 along the guiding passage 3). The second flow restriction 6 may for example comprise at least one valve. The second flow restriction 6 may be configured such that it can either impede or obstruct pressure medium flow or not impede or obstruct pressure medium flow. In other words, the second flow restriction 6 may be configured such that it is either “off”, not impeding or obstructing pressure medium flow at all, or “on”, impeding or obstructing pressure medium flow. The second flow restriction 6 may be normally off, or open. The second flow restriction 6 may for example be a normally open valve.

The guiding passage 3 may be configured to provide a certain flow resistance for the pressure medium guided from the pressure vessel 2 towards the pressure medium sink 4 when the first flow restriction 5 is kept completely ‘open’ while pressure medium is being withdrawn from the pressure vessel 2 for example by way of constructing or designing it in a special way. For example, the guiding passage 3 may be configured to have a certain cross-sectional area perpendicular to a longitudinal direction of the guiding passage 3 and/or the guiding passage 3 may be constructed, e.g., so that it is not straight but has multiple bends over a certain length of the guiding passage 3 along the longitudinal direction of the guiding passage 3, or such that it is meandering over a certain length of the guiding passage 3 along the longitudinal direction of the guiding passage 3, at least as seen from a certain direction. At least the part of the guiding passage 3 between the second flow restriction 6 and the first flow restriction 5 may be constructed or designed in such way. As illustrated in FIG. 1, the guiding passage 3 may have at least two bends between the second flow restriction 6 and the first flow restriction 5. FIG. 2 illustrates a case where the guiding passage 3 is meandering between the second flow restriction 6 and the first flow restriction 5. Except for the meandering of the guiding passage 3 between the second flow restriction 6 and the first flow restriction 5, the press apparatus 1 illustrated in FIG. 2 is the same as the press apparatus 1 illustrated in FIG. 1. Such meandering could be implemented in the guiding passage(s) of any other disclosed embodiments of the present invention, such as the guiding passage(s) of any of the illustrated embodiments of the present invention, e.g., in FIGS. 7-9 which are described in the following.

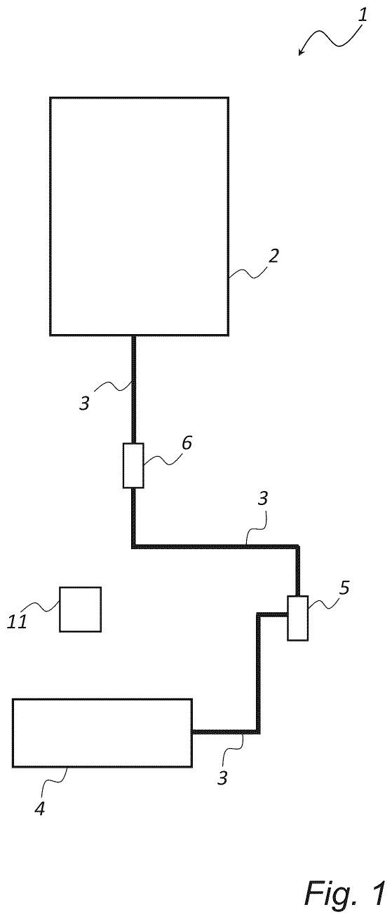

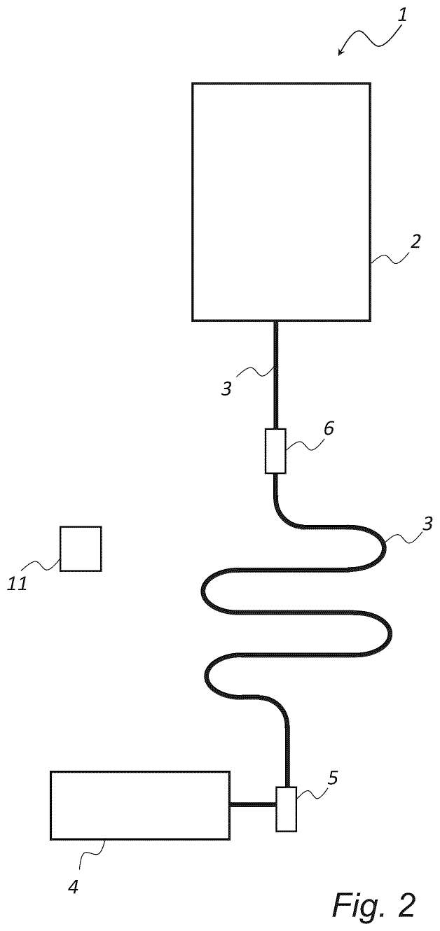

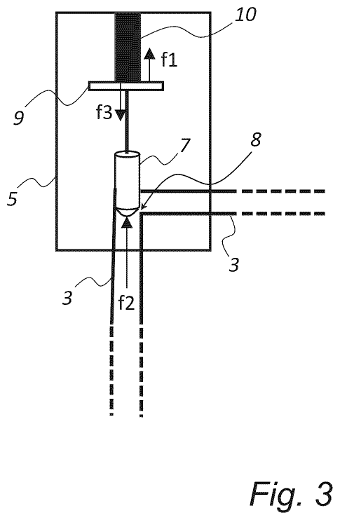

FIG. 3 is a schematic view of the first flow restriction 5 in accordance with an embodiment of the present invention. It is to be noted that all depicted components of the first flow restriction 5 are illustrated in FIG. 3 only very schematically.

The first flow restriction 5 comprises a flow restriction body 7 that is movable between at least a closed position and a maximally open position. According to the embodiment illustrated in FIG. 3, the flow restriction body 7 is movable upwards and downwards in FIG. 3. Portions of the guiding passage 3 illustrated in FIGS. 1 and 2 are depicted in FIG. 3. The portion of the guiding passage 3 that is to the bottom in FIG. 3 is at the inlet of the first flow restriction 5 (i.e., towards the second flow restriction 6 in FIGS. 1 and 2), and the portion of the guiding passage 3 that is to the right in FIG. 3 is at the outlet of the first flow restriction 5 (i.e., towards the pressure medium sink 4 in FIGS. 1 and 2).

When the flow restriction body 7 is moved out of the closed position an opening 8 is created, wherein the size of the opening 8 becomes larger the closer the flow restriction body 7 is to the maximally open position. The extent to which pressure medium flow is permitted through the first flow restriction 5 depends on the size of the opening 8 if any. According to the embodiment of the present invention illustrated in FIG. 3, the closed position of the flow restriction body 7 is reached by the flow restriction body 7 moving downwards in FIG. 3 and the maximally open position of the flow restriction body 7 is reached by the flow restriction body 7 moving upwards in FIG. 3.

According to the embodiment of the present invention illustrated in FIG. 3, the first flow restriction 5 comprises an actuator 9 and a counterforce mechanism 10, which are both illustrated very schematically in FIG. 3. The actuator 9 is configured to controllably and selectively generate the first force acting on the flow restriction body 7 to urge it either towards the maximally open position or towards the closed position.

During controlled withdrawal of pressure medium from the pressure vessel 2, the size of the opening 8 is determined at least by (i) a first force f1 acting on the flow restriction body 7 to urge it either towards the maximally open position or towards the closed position, controllably and selectively generated by the actuator 9, (ii) a second force f2 acting on the flow restriction body 7 to urge it towards the maximally open position, generated by a pressure of pressure medium in the guiding passage 3 (e.g., pressure of pressure medium in the guiding passage 3 upstream and at the first flow restriction 5), and (iii) a third force f3 acting on the flow restriction body 7 to urge it towards the closed position if the first force f1 acts on the flow restriction body 7 to urge it towards the maximally open position, or towards the maximally open position if the first force f1 acts on the flow restriction body 7 to urge it towards the closed position, the third force f3 being generated by the counterforce mechanism 10.

Thus, the first flow restriction 5 may either be normally closed—in case the actuator 9 is configured to controllably and selectively generate the first force acting on the flow restriction body 7 to urge it towards the maximally open position and the third force f3 acts on the flow restriction body 7 to urge it towards the closed position—or normally open—in case the actuator 9 is configured to controllably and selectively generate the first force acting on the flow restriction body 7 to urge it towards the closed position and the third force f3 acts on the flow restriction body 7 to urge it towards the maximally open position.

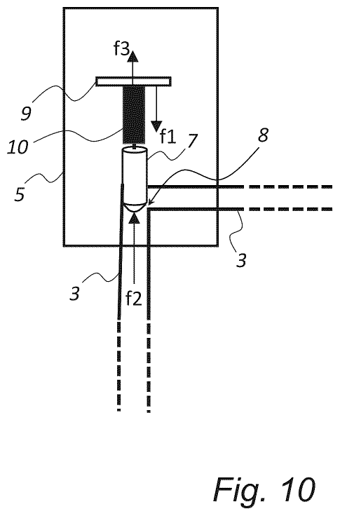

The case where the first flow restriction 5 is normally closed is illustrated in FIG. 3. The case where the first flow restriction 5 is normally open is illustrated in FIG. 10. Except for the fact that the first flow restriction 5 illustrated in FIG. 10 is normally open (and the different position of the counterforce mechanism 10), the first flow restriction 5 illustrated in FIG. 10 is the same or substantially the same as the first flow restriction 5 illustrated in FIG. 3. The counterforce mechanism 10 in the first flow restriction 5 illustrated in FIG. 3 may for example include a compression spring. The counterforce mechanism 10 in the first flow restriction 5 illustrated in FIG. 10 may for example include a compression spring if the counterforce mechanism 10 is mounted in relation to the actuator 9 as illustrated in FIG. 10, or a tension spring if the counterforce mechanism 10 would be mounted on the other side of the actuator 9 (such as illustrated in FIG. 3).

It is to be noted that the lengths of the arrows illustrating the first force f1, the second force f2 and the third force f3, respectively, in FIGS. 3 and 10 do not necessarily imply anything about the magnitudes of the forces f1, f2 and f3 relatively to each other. The arrows are merely included in FIGS. 3 and 10 to illustrate the directions in which the respective ones of the first force f1, the second force f2 and the third force f3 may be acting relatively to each other.

The flow restriction body 7 could possibly be referred to as the first flow restriction's 5 modulating element. In case the first flow restriction 5 comprises a valve, the flow restriction body 7 may be referred to as the valve's modulating element. For example, and in accordance with the embodiments of the present invention illustrated in FIGS. 3 and 10, the first flow restriction 5 may comprise a needle valve or the like, and the flow restriction body 7 may comprise or be constituted by the needle-shaped plunger of the needle valve. It is again noted that FIGS. 3 and 10 are schematic views of the first flow restriction 5, and it is further noted that certain components that may be included in the first flow restriction 5 are omitted in FIGS. 3 and 10. For example in case the first flow restriction 5 comprises or is constituted by a needle valve, the first flow restriction 5 may further comprise a seat, which is not shown in FIG. 3 or 10, wherein the shape of the needle-shaped plunger matches the shape of the seat such that the needle-shaped plunger fits in the seat when the needle-shaped plunger (or flow restriction body 7) is in the closed position.

The actuator 9 may for example comprise a membrane actuator and a proportional pressure regulator, which is configured to act on the membrane actuator such that the membrane actuator generates the first force f1. The actuator 9 may be configured such that the first force f1 generated by the actuator 9 can be varied stepwise, or continuously.

The counterforce mechanism 10 may for example comprise a spring element that may be biased to generate the third force f3 acting on the flow restriction body 7 to urge it towards the closed position if the first force f1 acts on the flow restriction body 7 to urge it towards the maximally open position, or towards the maximally open position if the first force f1 acts on the flow restriction body 7 to urge it towards the closed position. The counterforce mechanism 10 may for example comprise a spring or a gas spring (e.g., an air spring), which may be controllable. The third force f3, acting on the flow restriction body 7 to urge it towards the closed position if the first force f1 acts on the flow restriction body 7 to urge it towards the maximally open position, or towards the maximally open position if the first force f1 acts on the flow restriction body 7 to urge it towards the closed position, and generated by the counterforce mechanism 10, may be constant, or substantially constant. The third force may be set at manufacture of the first flow restriction 5, e.g., by choice of the particular type of counterforce mechanism 10 used in the first flow restriction 5. Thus, the third force f3 may differ for different types of first flow restriction 5, but may otherwise be constant, or substantially constant. If the counterforce mechanism 10 comprises a spring element, the third force f3 may be based on a spring constant of the spring element.

The first force f1 may vary, since it is selectively and controllably generated by the actuator 9. The second force f2 will typically vary during controlled withdrawal of pressure medium from the pressure vessel 2, since pressure of pressure medium in the guiding passage 3 (or pressure of pressure medium in the guiding passage 3 upstream and at the first flow restriction 5) will generally vary during withdrawal of pressure medium from the pressure vessel 2.

During controlled withdrawal of pressure medium from the pressure vessel 2, there may be a predetermined relationship between the second force and the first force, for the particular third force. The predetermined relationship may entail that for the particular third force, there are a plurality of values or a set of values of the first force, or a range of values of the first force, which result in a certain plurality of respective values of the second force or a certain set of respective values of the second force, or a certain range of respective values of the second force. Thus, according to the predetermined relationship, for each value of a plurality of values or a set of values of the first force there may be a corresponding value of the second force resulting from that particular value of the first force generated by the actuator 9. The predetermined relationship may for example have been established or determined by, for the particular third force generated by the counterforce mechanism 10, a set of measurements of values of the second force resulting from different values of the first force generated by the actuator 9 during controlled withdrawal of pressure medium from the pressure vessel 2.

The set of measurements may have been obtained not during an actual treatment cycle wherein at least on article is treated in the press apparatus, but before an actual treatment cycle and during a ‘test’ or ‘training’ cycle, which may have been carried out for the purpose of determining the said relationship. During such a ‘test’ or ‘training’ cycle, the pressure in the pressure vessel 2 may be increased to a pressure level at which treatment of articles is contemplated to occur by introducing pressure medium into the pressure vessel 2, and after the pressure in the pressure vessel 2 has reached this pressure level, pressure medium may be withdrawn from the pressure vessel 2 via the guiding passage 3 to reduce the pressure in the pressure vessel 2. The set of measurements may be obtained during controlled withdrawal of pressure medium from the pressure vessel 2 during such a ‘test’ or ‘training’ cycle. During such a ‘test’ or ‘training’ cycle, the actuator 9 may be controlled to generate a certain constant value of the first force, and it may then be measured what the resulting value of the second force is. This may be carried out for a series of different constant values of the first force generated by the actuator 9 in order to obtain the set of measurements used for establishing or determining the predetermined relationship.

During controlled withdrawal of pressure medium from the pressure vessel 2, for each of the different values of the first force generated by the actuator 9 it may be measured what the resulting value of the second force is. The measurements of values of the second force may for example be carried out by means of measurements of pressure of pressure medium in the guiding passage 3. Thus, the values of the second force must not necessarily be directly measured, but may be indirectly measured by means of, e.g., measurements of pressure of pressure medium in the guiding passage 3. Measurements of pressure of pressure medium in the guiding passage 3 may for example be carried out by means of a pressure sensor as known in the art (not shown in the figures). Though not illustrated in FIGS. 1 and 2, the press apparatus 1 may comprise one or more pressure sensors e.g., for sensing or measuring pressure of pressure medium in the guiding passage 3. For example, there may be provided a pressure sensor configured to sense or measure pressure in the guiding passage 3 at the point where the guiding passage 3 enters the pressure vessel 2 and/or a pressure sensor configured to sense or measure pressure in the guiding passage 3 upstream of and at the first flow restriction 5. Any pressure sensor may for example be arranged or mounted at a selected position along the guiding passage 3. Any pressure sensor may for example be arranged or mounted on one or more pipes, tubes or conduits which may implement or realize the guiding passage 3. In alternative or in addition, any pressure sensor may be arranged or mounted on, e.g., some other component (not shown in the figures) which may be coupled to the pressure vessel 2, such as a pipe, tube, conduit or circuit, etc., for pressure medium.

Possibly, a pressure relief device, such as, for example, a relief valve or a rupture disc or the like (not shown in FIGS. 1 and 2) may be coupled to the first flow restriction 5 and which may be used in case of any malfunction of the first flow restriction 5.

With further reference to FIGS. 1 and 2, the press apparatus 1 comprises at least one control and/or processing unit, schematically indicated at 11.

The at least one control and/or processing unit 11 is configured to determine a plurality of values of the second force such that the corresponding values of the pressure of pressure medium in the guiding passage 3 correspond to a pressure reduction sequence for reducing the pressure of pressure medium in the guiding passage 3 over time, and determine, based on the predetermined relationship, a plurality of values of the first force corresponding to the respective ones of the plurality of values of the second force. The at least one control and/or processing unit 11 is configured to, during at least a portion of time while pressure medium is being controllably withdrawn from the pressure vessel 2, control the actuator 9 to generate the plurality of values of the first force such that the pressure of pressure medium in the guiding passage 3 is reduced over time in accordance with the pressure reduction sequence. The pressure reduction sequence might be referred to as a pressure gradient.

Thus, the predetermined relationship may first be used to define a pressure reduction sequence, and then the actuator 9 may be controlled such that the pressure of pressure medium in the guiding passage 3 is reduced over time in accordance with the pressure reduction sequence, by controlling the actuator 9 to generate the plurality of values of the first force that will result in the pressure of pressure medium in the guiding passage 3 being reduced over time according to the pressure reduction sequence. The determination of the plurality of values of the second force may entail selecting values of the second force among the plurality of respective values of the second force or a certain set of respective values of the second force, or a certain range of values of the second force, as described herein, to form a succession of values of the second force for which the corresponding values of the pressure of pressure medium in the guiding passage 3 are monotonically decreasing. Such monotonically decreasing values of the pressure of pressure medium in the guiding passage 3 may form the pressure reduction sequence.

With further reference to FIGS. 1 and 2, the at least one control and/or processing unit 11 may be configured to, prior to the at least a portion of time, control the second flow restriction 6 to not impede or obstruct pressure medium flow therethrough, thereby causing pressure medium to be withdrawn from the pressure vessel 2 by the pressure medium being guided from the pressure vessel 2 towards the pressure medium sink 4 via the guiding passage 3.

The above-mentioned predetermined relationship may have been determined such that for the predetermined relationship, a combination of the first force and the second force is in balance with the third force, while the flow restriction body 7 is away from the closed position. By a combination of the first force and the second force being in balance with the third force, it may be meant that there is no or only a very small net force acting on the flow restriction body 7 such that the flow restriction body 7 is in or very close to force equilibrium. Thus, for each value of a plurality of values or a set of values of the first force there may be a corresponding value of the second force resulting from that particular value of the first force generated by the actuator 9, for the particular third force, at which the flow restriction body 7 is stationary or substantially stationary and away from the closed position.

The at least one control and/or processing unit 11 may be connected with the first flow restriction 5, the second flow restriction 6 and/or any other component in the press apparatus 1 for example to control operation thereof (e.g., to control the actuator 9 of the first flow restriction 5). Such connection may be implemented or realized by any wireless and/or wired means for example such as known in the art. Such connection may be a communicative connection, such that the at least one control and/or processing unit 11 may be able to communicate with the first flow restriction 5, the second flow restriction 6 and/or any other component in the press apparatus 1 via wired and/or wireless communication means or techniques, for example via any appropriate wired and/or wireless communication means or techniques as known in the art, for transmitting messages, instructions, data, commands, etc., from the at least one control and/or processing unit 11 to the first flow restriction 5, the second flow restriction 6 and/or any other component in the press apparatus 1 and possibly vice versa.

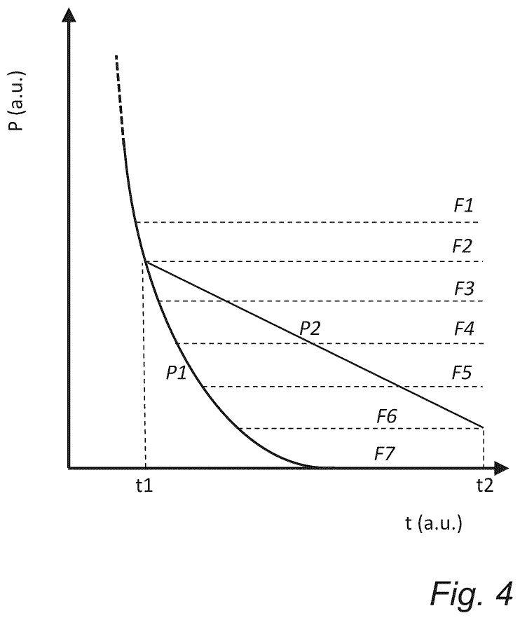

FIG. 4 is a schematic graph which illustrates principles of embodiments of the present invention such as has been described in the foregoing, e.g., with reference to FIGS. 1 to 3 and 10. More specifically, FIG. 4 is a schematic graph of pressure P in the pressure vessel versus time t (with both P and t being in arbitrary units) during at least a portion of time while pressure medium is being withdrawn from the pressure vessel 2.

The curve P1 illustrates how the pressure P in the pressure vessel 2 may decrease over time if the first flow restriction and possibly the second flow restriction if any would be completely ‘open’ during the withdrawal of the pressure medium from the pressure vessel 2, i.e., if the first flow restriction and possibly the second flow restriction if any would not obstruct or impede pressure medium flow at all during the withdrawal of the pressure medium from the pressure vessel 2. This may correspond to a case where the actuator 9 is controlled to generate a first force having a sufficiently high value to ensure that the flow restriction body 7 is kept in the maximally open position during the withdrawal of the pressure medium from the pressure vessel 2 (e.g., in case the first flow restriction 5 is a normally closed flow restriction).

The curve P2 illustrates how the pressure P in the pressure vessel may decrease over time if the first flow restriction is employed in accordance with one or more embodiments of the present invention, particularly if the actuator 9 is controlled during at least a portion of time while pressure medium is being controllably withdrawn from the pressure vessel 2 such as described herein, e.g., such as described in the foregoing with reference to FIGS. 1 to 3 and 10.

The lines F1 to F7 in FIG. 4 denote certain values of the first force generated by the actuator 9. The line F7 coincides with the horizontal axis. The values of the pressure P in the pressure vessel at the respective points where the lines F1 to F7 cross with the curve P1 correspond to the pressure of pressure medium in the guiding passage 3 at which the combination of the respective values F1 to F7 of the first force with the second force that may be acting on the flow restriction body 7 to urge it towards the maximally open position, generated by the pressure of pressure medium in the guiding passage 3, is not large enough in comparison to the third force to cause the flow restriction body 7 to be out of the closed position (e.g., in case the first flow restriction 5 is a normally closed flow restriction).

At least some of F1 to F7 may correspond to monotonically increasing values, or successively different values, of the first force that may be generated by the actuator 9. For example where the actuator 9 comprises a membrane actuator and a proportional pressure regulator configured to act on the membrane actuator such that the membrane actuator generates the first force, F1 to F7 may for example correspond to pressures of 0 bar, 1 bar, 2 bar, 3 bar, 4 bar, 5 bar and 6 bar, respectively (e.g. in case the first flow restriction 5 is a normally closed flow restriction).

F7 may correspond to a value of the first force that is sufficient to ensure that the flow restriction body 7 is kept in the maximally open position while pressure medium is being withdrawn from the pressure vessel 2, i.e., that the first flow restriction 5 is kept completely ‘open’, i.e., not obstructing or impeding pressure medium flow at all, while pressure medium is being withdrawn from the pressure vessel 2.

As mentioned, during controlled withdrawal of pressure medium from the pressure vessel 2, there is a predetermined relationship between the second force and the first force, for the particular third force. It can be determined a plurality of values of the second force such that the corresponding values of the pressure of pressure medium in the guiding passage 3 correspond to a pressure reduction sequence for reducing the pressure of pressure medium in the guiding passage 3 over time. The curve P2 may correspond to such a pressure reduction sequence. Based on the predetermined relationship, a plurality of values of the first force corresponding to the respective ones of the plurality of values of the second force may be determined.

In accordance with the embodiment illustrated in FIG. 4, by controlling the actuator 9 such that the first force, during the at least a portion of time, varies between F2 and F6, the pressure medium in the guiding passage—and hence the pressure P in the pressure vessel which is proportional to the pressure medium in the guiding passage—can be made to decrease over time according to the curve P2, which in the illustrated example is a straight line having a certain negative slope from time t1 to time t2. Thus, from time t1 to time t2, the rate of reduction of the pressure P in the pressure vessel may be controlled to be constant, or at least substantially constant. At each point on the curve P2, a combination of the first force and the second force is in balance with the third force, while the flow restriction body 7 is away from the closed position but not in a fully open position or the maximally open position. Thus, by means of the controlling of the actuator 9 as described herein, a high precision in controlling the rate of reduction of the pressure of pressure medium in the guiding passage 3—and thereby of the pressure P in the pressure vessel 2—may be achieved. While FIG. 4 illustrates the curve P2 as a straight line, it is to be understood that the curve P2 could have another shape. Thus, the rate of reduction of the pressure P in the pressure vessel from time t1 to time t2 may not necessarily be constant, or at least substantially constant, but may be controlled so as to at least momentarily vary during the period of time from time t1 to time t2. For example, the curve P2 could instead of a straight line be a curve having a shape similar to or resembling a parabola. Thus, the pressure P in the pressure vessel must not necessarily be made to decrease over time according to a straight line having a certain negative slope from time t1 to time t2, which is merely an example of how the pressure P in the pressure vessel can be controlled to decrease over time.

It is to be understood that the graph in FIG. 4 may illustrate a reduction of the pressure P in the pressure vessel from time t1 to time t2 according to ideal, or close to ideal, operating conditions of the press apparatus 1. For example, the graph in FIG. 4 may neglect any pressure medium leakage that may occur in one or more components of the press apparatus 1, such as in the first flow restriction 5, in any pipe(s), tube(s) or conduit(s) implementing or realizing the guiding passage 3, for example. In case of any such pressure medium leakage, the curves F1-F6 in FIG. 4 may not be exactly in accordance with, e.g., a straight line as illustrated in FIG. 4, but may deviate somewhat from the shape of such a type of curve and exhibit, e.g., one or more kinks.

In case the press apparatus 1 comprises a second flow restriction 6 such as illustrated in FIGS. 1 and 2, both the curve P1 and the curve P2 presuppose that the second flow restriction 6 is completely ‘open’, i.e., that the second flow restriction does not obstruct or impede pressure medium flow at all, while pressure medium is being withdrawn from the pressure vessel 2.

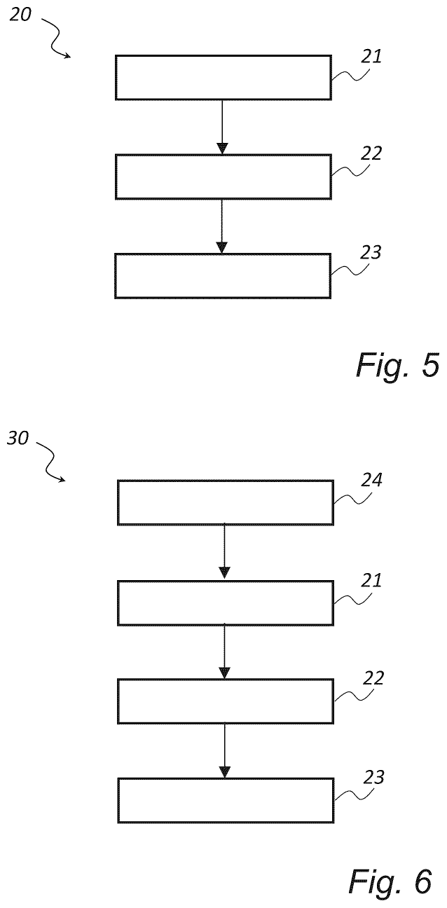

FIG. 5 is a schematic flowchart of a method 20 according to an embodiment of the present invention. The method 20 is a method for press apparatus. The press apparatus comprises a pressure vessel arranged to hold pressure medium therein. The press apparatus comprises a guiding passage configured to connect the pressure vessel with a pressure medium sink and to withdraw pressure medium from the pressure vessel by guiding pressure medium from the pressure vessel towards the pressure medium sink, thereby reducing pressure in the pressure vessel. The guiding passage comprises at least a first flow restriction configured to control the extent to which pressure medium flow in the guiding passage is obstructed or impeded by controlling extent to which pressure medium flow is permitted through the first flow restriction. The first flow restriction comprises a flow restriction body that is movable between at least a closed position and a maximally open position. When the flow restriction body is moved out of the closed position an opening is created, wherein the size of the opening becomes larger the closer the flow restriction body is to the maximally open position. The extent to which pressure medium flow is permitted through the first flow restriction depends on the size of the opening if any. During controlled withdrawal of pressure medium from the pressure vessel the size of the opening is determined at least by (i) a first force acting on the flow restriction body to urge it either towards the maximally open position or towards the closed position, controllably and selectively generated by an actuator, (ii) a second force acting on the flow restriction body to urge it towards the maximally open position, generated by a pressure of pressure medium in the guiding passage, and (iii) a third force acting on the flow restriction body to urge it towards the closed position if the first force acts on the flow restriction body to urge it towards the maximally open position, or towards the maximally open position if the first force acts on the flow restriction body to urge it towards the closed position, the third force generated by a counterforce mechanism. During controlled withdrawal of pressure medium from the pressure vessel, there is a predetermined relationship between the second force and the first force, for the particular third force.

The method 20 comprises, at 21, determining a plurality of values of the second force such that the corresponding values of the pressure of pressure medium in the guiding passage correspond to a pressure reduction sequence for reducing the pressure of pressure medium in the guiding passage over time. At 22, it is determined, based on the predetermined relationship, a plurality of values of the first force corresponding to the respective ones of the plurality of values of the second force. At 23, during at least a portion of time while pressure medium is being controllably withdrawn from the pressure vessel, the actuator is controlled to generate the plurality of values of the first force such that the pressure of pressure medium in the guiding passage is reduced over time in accordance with the pressure reduction sequence.

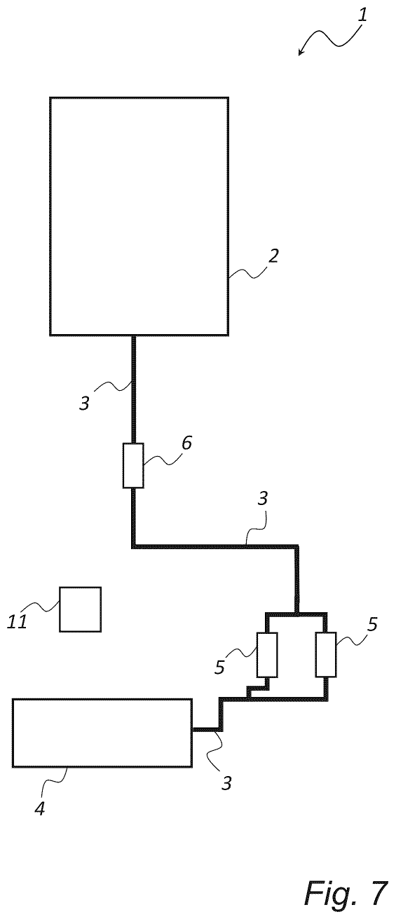

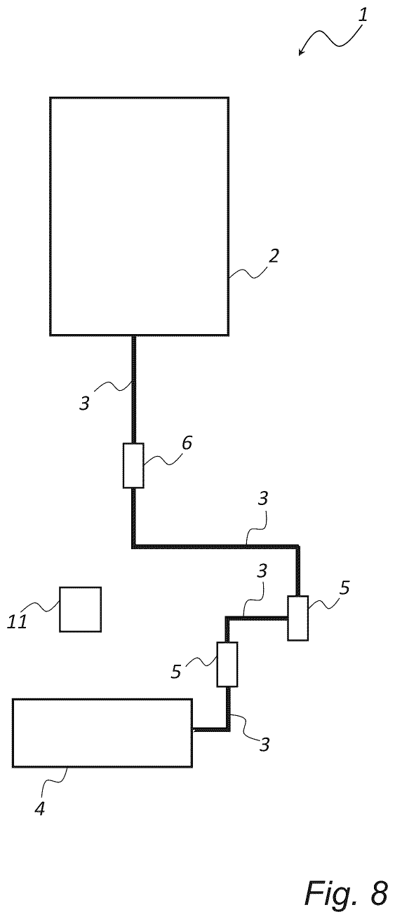

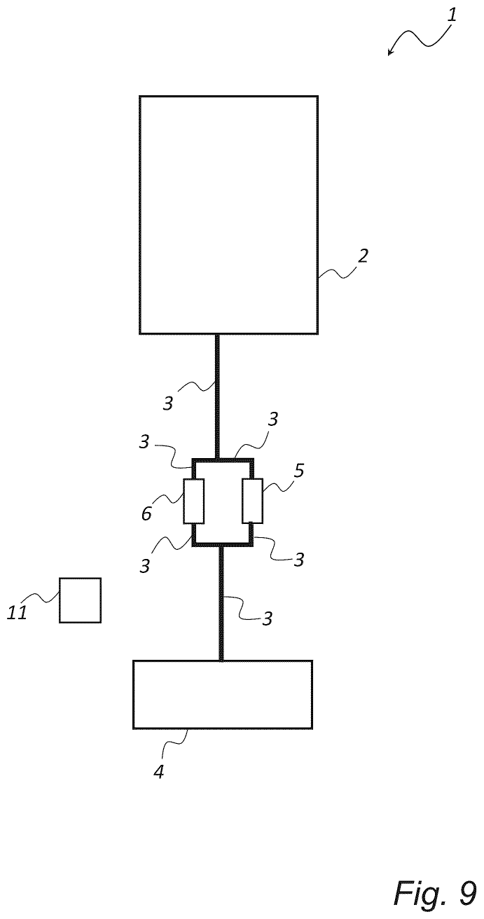

FIG. 6 is a schematic flowchart of a method 30 according to another embodiment of the present invention. The method 30 illustrated in FIG. 6 is similar to the method 20 illustrated in FIG. 5, and includes the operations 21, 22 and 23 as in the method 20 illustrated in FIG. 5. In contrast to the method 20 illustrated in FIG. 5, for the method 30 illustrated in FIG. 6, the guiding passage further comprises a second flow restriction configured to control the extent to which pressure medium flow in the guiding passage is obstructed or impeded by controlling the extent to which pressure medium flow is permitted through the second flow restriction, wherein the second flow restriction is arranged upstream the first flow restriction. Further in contrast to the method 20 illustrated in FIG. 5, the method 30 comprises, prior to the at least a portion of time, at 24, controlling the second flow restriction to not impede or obstruct pressure medium flow therethrough, thereby causing pressure medium to be withdrawn from the pressure vessel by the pressure medium being guided from the pressure vessel towards the pressure medium sink via the guiding passage.

While FIGS. 1 and 2 depict a single first flow restriction 5, it is to be understood that the press apparatus 1 could possibly comprise one or more additional flow restrictions, each of which may be comprised in the guiding passage 3. FIGS. 7 and 8 schematically illustrate different alternative configurations to the configurations illustrated in FIGS. 1 and 2. Thus, each of FIGS. 7 and 8 is a schematic view of a press apparatus 1 according to an embodiment of the present invention. The same reference numerals in FIGS. 7 and 8 and FIGS. 1 and 2 denote the same or similar components, having the same or similar function.

According to the embodiment of the present invention illustrated in FIG. 7, there are two first flow restrictions 5 which are connected in parallel. It could be provided more than two first flow restrictions connected in parallel. In the embodiment of the present invention illustrated in FIG. 7, the second flow restriction 6 may be omitted. The second flow restriction 6 could also be omitted in the embodiments of the present invention illustrated in FIGS. 1 and 2.

According to the embodiment of the present invention illustrated in FIG. 8, there are two first flow restrictions 5 connected in series. It could be provided more than two first flow restrictions connected in series. In the embodiment of the present invention illustrated in FIG. 8, the second flow restriction 6 may be omitted.

Possibly, there could be provided a plurality of first flow restrictions, wherein some may be connected in parallel, and some may be connected in series.

Each or any of one or more additional flow restrictions if any may be arranged similar to or the same as the first flow restriction 5, and may hence be configured to control the extent to which pressure medium flow in the guiding passage 3 is obstructed or impeded by controlling extent to which pressure medium flow is permitted through the additional flow restriction, and the additional flow restriction may comprise a flow restriction body that is movable between at least a closed position and a maximally open position, such as for the first flow restriction 5 as described herein.

FIG. 9 is a schematic view of a press apparatus 1 according to another embodiment of the present invention. The same reference numerals in FIG. 9 and FIGS. 1 and 2 denote the same or similar components, having the same or similar function. The embodiment of the present invention illustrated in FIG. 9 differs from the embodiments of the present invention illustrated in FIGS. 1 and 2 in that according to the embodiment of the present invention illustrated in FIG. 9, the first flow restriction 5 and the second flow restriction 6 are connected in parallel.

In conclusion, a method in a press apparatus is disclosed. The press apparatus comprises a pressure vessel and a guiding passage for guiding pressure medium out of the pressure vessel to reduce pressure in the pressure vessel. The guiding passage comprises a first flow restriction comprising a flow restriction body that is movable between at least a closed position and a maximally open position, wherein when the flow restriction body is moved out of the closed position an opening is created the size of which during controlled withdrawal of pressure medium from the pressure vessel is determined by: a first force acting on the flow restriction body to urge it either towards the maximally open position or towards the closed position, generated by an actuator, a second force acting on the flow restriction body to urge it towards the maximally open position, generated by a pressure of pressure medium in the guiding passage, and a third force acting on the flow restriction body to urge it towards the closed position if the first force acts on the flow restriction body to urge it towards the maximally open position, or towards the maximally open position if the first force acts on the flow restriction body to urge it towards the closed position, the third force being generated by a counterforce mechanism. The actuator is controlled in accordance with a predetermined relationship between the second force and the first force, for the particular third force, such that the pressure of pressure medium in the guiding passage is reduced over time in accordance with a pressure reduction sequence.

While the present invention has been illustrated in the appended drawings and the foregoing description, such illustration is to be considered illustrative or exemplifying and not restrictive; the present invention is not limited to the disclosed embodiments. Other variations to the disclosed embodiments can be understood and effected by those skilled in the art in practicing the claimed invention, from a study of the drawings, the disclosure, and the appended claims. In the appended claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A method in a press apparatus comprising a pressure vessel arranged to hold pressure medium therein and a guiding passage configured to connect the pressure vessel with a pressure medium sink and to withdraw pressure medium from the pressure vessel by guiding pressure medium from the pressure vessel towards the pressure medium sink, thereby reducing pressure in the pressure vessel, the guiding passage comprising at least a first flow restriction configured to control the extent to which pressure medium flow in the guiding passage is obstructed or impeded by controlling extent to which pressure medium flow is permitted through the first flow restriction, the first flow restriction comprising a flow restriction body that is movable between at least a closed position and a maximally open position, wherein when the flow restriction body is moved out of the closed position an opening is created, wherein the size of the opening becomes larger the closer the flow restriction body is to the maximally open position, wherein the extent to which pressure medium flow is permitted through the first flow restriction depends on the size of the opening if any, and wherein during controlled withdrawal of pressure medium from the pressure vessel the size of the opening is determined at least by a first force acting on the flow restriction body to urge it either towards the maximally open position or towards the closed position, controllably and selectively generated by an actuator, a second force acting on the flow restriction body to urge it towards the maximally open position, generated by a pressure of pressure medium in the guiding passage, and a third force acting on the flow restriction body to urge it towards the closed position if the first force acts on the flow restriction body to urge it towards the maximally open position, or towards the maximally open position if the first force acts on the flow restriction body to urge it towards the closed position, the third force generated by a counterforce mechanism, wherein there is a predetermined relationship between the second force and the first force, for the particular third force, the method comprising:
determining, a plurality of values of the second force such that the corresponding values of the pressure of pressure medium in the guiding passage correspond to a pressure reduction sequence for reducing the pressure of pressure medium in the guiding passage over time;
determining, based on the predetermined relationship, a plurality of values of the first force corresponding to the respective ones of the plurality of values of the second force; and
during at least a portion of time while pressure medium is being controllably withdrawn from the pressure vessel, controlling the actuator to generate the plurality of values of the first force such that the pressure of pressure medium in the guiding passage is reduced over time in accordance with the pressure reduction sequence.

2. A method according to claim 1, wherein the predetermined relationship has been determined by, for the particular third force generated by the counterforce mechanism, a set of measurements of values of the second force resulting from different values of the first force generated by the actuator carried out prior to the method steps defined in claim 1.

3. A method according to claim 1, wherein for the predetermined relationship, a combination of the first force and the second force is in balance with the third force while the flow restriction body is away from the closed position but not in the maximally open position.

4. A method according to claims 1, wherein the guiding passage further comprises a second flow restriction configured to control the extent to which pressure medium flow in the guiding passage is obstructed or impeded by controlling the extent to which pressure medium flow is permitted through the second flow restriction, wherein the second flow restriction is arranged upstream the first flow restriction, and the method further comprises, prior to the at least a portion of time:
controlling the second flow restriction to not impede or obstruct pressure medium flow therethrough, thereby causing pressure medium to be withdrawn from the pressure vessel by the pressure medium being guided from the pressure vessel towards the pressure medium sink via the guiding passage.

5. A method according to claim 4, wherein the withdrawal of pressure medium from the pressure vessel is for reducing the pressure in the pressure vessel from a high pressure level towards a low pressure level, and wherein the second flow restriction is configured such that it is capable of operating at one or more pressure levels which at least include the high pressure level and the first flow restriction is configured such that it is capable of operating at one or more pressure levels which at least include an intermediate pressure level between the high pressure level and the low pressure level, wherein said controlling of the actuator is carried out after the pressure in the pressure vessel has been reduced such that the pressure in the pressure vessel is equal to or less than the intermediate pressure level.

6. A method according to claim 4, wherein said controlling of the actuator is carried out while the second flow restriction continues not to be obstructing or impeding pressure medium flow.

7. A method according to claim 5, wherein the one or more pressure operating levels at which the second flow restriction is capable of operating at is equal to or less than 6000 bar, and/or wherein the one or more pressure operating levels at which the first flow restriction is capable of operating at is equal to or less than 400 bar.

8. A press apparatus comprising:
a pressure vessel arranged to hold pressure medium therein;
a guiding passage configured to connect the pressure vessel with a pressure medium sink and to withdraw pressure medium from the pressure vessel by guiding pressure medium from the pressure vessel towards the pressure medium sink, thereby reducing pressure in the pressure vessel; and
at least a first flow restriction comprised in the guiding passage and configured to control the extent to which pressure medium flow in the guiding passage is obstructed or impeded by controlling extent to which pressure medium flow is permitted through the first flow restriction, the first flow restriction comprising a flow restriction body that is movable between at least a closed position and a maximally open position, wherein when the flow restriction body is moved out of the closed position an opening is created, wherein the size of the opening becomes larger the closer the flow restriction body is to the maximally open position, wherein the extent to which pressure medium flow is permitted through the first flow restriction depends on the size of the opening if any, and wherein during controlled withdrawal of pressure medium from the pressure vessel the size of the opening is determined at least by a first force acting on the flow restriction body to urge it either towards the maximally open position or towards the closed position, controllably and selectively generated by an actuator, a second force acting on the flow restriction body to urge it towards the maximally open position, generated by a pressure of pressure medium in the guiding passage, and a third force acting on the flow restriction body to urge it towards the closed position if the first force acts on the flow restriction body to urge it towards the maximally open position, or towards the maximally open position if the first force acts on the flow restriction body to urge it towards the closed position, the third force generated by a counterforce mechanism, wherein there is a predetermined relationship between the second force and the first force, for the particular third force;
the press apparatus further comprising at least one control and/or processing unit configured to:
determine a plurality of values of the second force such that the corresponding values of the pressure of pressure medium in the guiding passage correspond to a pressure reduction sequence for reducing the pressure of pressure medium in the guiding passage over time;
determine, based on the predetermined relationship, a plurality of values of the first force corresponding to the respective ones of the plurality of values of the second force; and
during at least a portion of time while pressure medium is being controllably withdrawn from the pressure vessel, control the actuator to generate the plurality of values of the first force such that the pressure of pressure medium in the guiding passage is reduced over time in accordance with the pressure reduction sequence.

9. A press apparatus according to claim 8, wherein the first flow restriction comprises at least one valve.

10. A press apparatus according to claim 8, wherein the first flow restriction comprises at least one seat valve or at least one needle valve.

11. (canceled)

12. A press apparatus according to claim 8, wherein the actuator comprises a membrane actuator and a proportional pressure regulator configured to act on the membrane actuator such that the membrane actuator generates the first force.

13. A press apparatus according to claim 8, wherein the actuator is configured such that the first force generated by the actuator can be varied stepwise or varied continuously.

14. (canceled)

15. A press apparatus according to claim 8, wherein the counterforce mechanism comprises a spring element that is biased to generate the third force acting on the flow restriction body to urge it either towards the closed position or towards the maximally open position.

16. A press apparatus according to claim 8, further comprising:
a second flow restriction comprised in the guiding passage and configured to control the extent to which pressure medium flow in the guiding passage is obstructed or impeded by controlling the extent to which pressure medium flow is permitted through the second flow restriction, wherein the second flow restriction is arranged upstream the first flow restriction;
wherein the at least one control and/or processing unit is configured to, prior to the at least a portion of time:
control the second flow restriction to not impede or obstruct pressure medium flow therethrough, thereby causing pressure medium to be withdrawn from the pressure vessel by the pressure medium being guided from the pressure vessel towards the pressure medium sink via the guiding passage.

17. A press apparatus according to claim 16, wherein the second flow restriction is configured such that it can either impede or obstruct pressure medium flow or not impede or obstruct pressure medium flow, and comprises at least one valve.

18. (canceled)

19. A press apparatus according to claim 16, wherein the withdrawal of pressure medium from the pressure vessel is for reducing the pressure in the pressure vessel from a high pressure level towards a low pressure level, wherein the second flow restriction is configured such that it is capable of operating at one or more pressure levels which at least include the high pressure level and the first flow restriction is configured such that it is capable of operating at one or more pressure levels which at least include an intermediate pressure level between the high pressure level and the low pressure level, and the one or more pressure operating levels at which the second flow restriction is capable of operating at is equal to or less than 6000 bar, and/or wherein the one or more pressure operating levels at which of the first flow restriction is capable of operating at is equal to or less than 400 bar.

20.-21. (cancelled)
